(19) United States
(12) Patent Application Publication
(10) Pub. No.: US 2019/0073407 A1
(43) Pub. Date: Mar. 7, 2019

(54) OPTIMIZED DATA SYNCHRONIZATION

(71) Applicant: QUALCOMM Incorporated, San Diego, CA (US)

(72) Inventors: Ravi Teja MANDAVILLI, Bangalore (IN); Sravan Kumar Reddy ACHAMOLA, Hyderabad (IN); Kiran KOONA, Miyapur (IN); Prathviraj SHETTY, Bangalore (IN)

(21) Appl. No.: 15/695,682

(22) Filed: Sep. 5, 2017

(51) Int. Cl. G06F 17/30; H04L 29/08

(52) U.S. Cl. CPC G06F 17/30575; H04L 67/1095

(57) ABSTRACT

Some examples of the disclosure include adjusting the frequency of network access to synchronize data on a mobile device based on the usage of the mobile device to optimize data synchronization and battery usage. One example includes increasing the time between data synchronization operations when the mobile device is not being frequently accessed.

### FIELD OF DISCLOSURE

This disclosure relates generally to mobile devices, and more specifically, but not exclusively, to battery conservation of mobile devices.

### BACKGROUND

Mobile devices (“UEs”) are becoming more prevalent and are being used more often by users. To keep mobile devices easy to carry around and pleasant for a user, mobile devices tend to have small batteries that reduce the overall weight of the device. However, the smaller a battery, the less charge it may carry resulting in less use time if battery power is not conserved appropriately. For example, battery draining is a major issue that users face when the mobile device is accessing mobile data for a long time. When mobile data is turned ON, the UE communicates with the network for a certain number of milliseconds. When a message/notification/mail comes to a user account/number, a synchronization process takes place on the UE at frequent intervals whether the user is actively using the UE or not. This synchronization process uses a significant amount of battery power that results in quicker battery drainage. To combat this issue, some UEs are configured to use features like ‘Ultra Data Saving mode’ etc. where the UE completely restricts background data from synchronizing, or the UE will synchronize data from network only when the user unlocks the UE for use. Because of these features, the user may miss some mails/messages that need immediate response or complete information that needs to be synchronized from the network will happen at once when the user unlocks the phone causing a data flush that may be annoying to the user.

Accordingly, there is a need for systems, apparatus, and methods that overcome the deficiencies of conventional approaches including the methods, system and apparatus provided hereby.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

In one aspect, a method of synchronizing data on a mobile device includes: setting a synchronization time period to x minutes, the synchronization time period configured to synchronize data on a mobile device with data on a network; determining a first number of operations performed on the mobile device during a first time period; when the first number of operations performed during the first time period is less than one, increasing the synchronization time period by y minutes, wherein y is an integer greater than zero; determining a second number of operations performed on the mobile device during a second time period; when the second number of operations performed during the second time period is less than one, increasing the synchronization time period by z minutes, wherein z is an integer greater than one; and when the second number of operations performed during the second time period is greater than one, decreasing the synchronization time period to x minutes.

In another aspect, a non-transitory computer-readable medium including contents that are configured to synchronize data on a mobile device by performing a method comprises: setting a synchronization time period to x minutes, the synchronization time period configured to synchronize data on a mobile device with data on a network; determining a first number of operations performed on the mobile device during a first time period; when the first number of operations performed during the first time period is less than one, increasing the synchronization time period by y minutes, wherein y is an integer greater than zero; determining a second number of operations performed on the mobile device during a second time period; when the second number of operations performed during the second time period is less than one, increasing the synchronization time period by z minutes, wherein z is an integer greater than one; and when the second number of operations performed during the second time period is greater than one, decreasing the synchronization time period to x minutes.

In still another aspect, an apparatus comprises: a memory; a processor coupled to the memory and configured to: set a synchronization time period to x minutes, the synchronization time period configured to synchronize data on a mobile device with data on a network; determine a first number of operations performed on the mobile device during a first time period; when the first number of operations performed during the first time period is less than one, increase the synchronization time period by y minutes, wherein y is an integer greater than zero; determine a second number of operations performed on the mobile device during a second time period; when the second number of operations performed during the second time period is less than one, increase the synchronization time period by z minutes, wherein z is an integer greater than one; and when the second number of operations performed during the second time period is greater than one, decrease the synchronization time period to x minutes.

Other features and advantages associated with the apparatus and methods disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates a partial flow diagram of synchronizing data in accordance with some examples of the disclosure.

FIG. 2 illustrates an exemplary partial block diagram of a UE in accordance with some examples of the disclosure.

FIG. 3 illustrates another exemplary partial block diagram of a UE in accordance with some examples of the disclosure.

FIG. 4 illustrates an exemplary partial method of synchronizing data in accordance with some examples of the disclosure.

FIG. 5 illustrates various electronic devices that may be used in connection with method and devices described herein in accordance with some examples of the disclosure.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

The exemplary methods, apparatus, and systems disclosed herein mitigate shortcomings of the conventional methods, apparatus, and systems, as well as other previously unidentified needs. For example, one approach of synchronizing the data on a UE is based on determining if a user is active or not. For approach, the UE determines if the user is actively accessing the UE frequently or not and then synchronizing the data based on this determination. If the UE is being frequently accessed, then the data should synchronize normally. But if the user has turned ON mobile data and is not checking or accessing the UE for a long time (i.e., X hours between checks/access) then the data should not get synchronized as frequently. For instance, the data should be synchronized in incremental fashion (i.e., X min, X+T1 min, X+T2 min) if the user is not checking the mobile for a long time. A UE idle condition may also be identified by its movement using sensors (e.g., Gyro, Accelerometer, compass sensors, etc.). If the UE is in a standalone condition for a long time, an algorithm may be usable to determine activity/access level of the user.

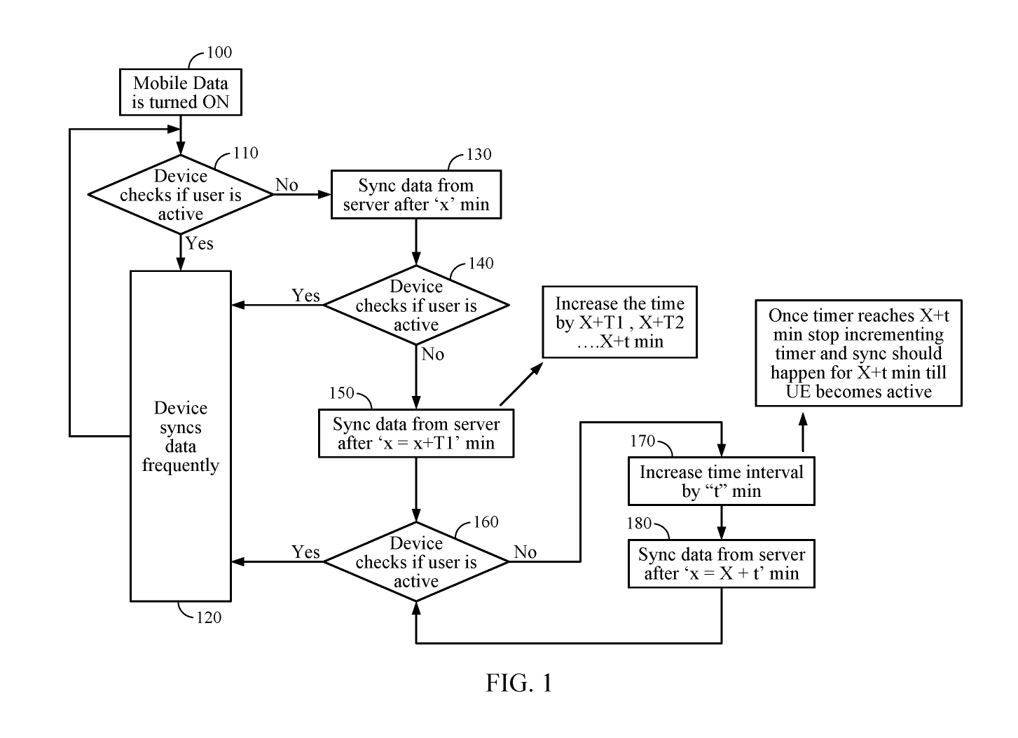

FIG. 1 illustrates a partial flow diagram of synchronizing data in accordance with some examples of the disclosure. As shown in FIG. 1, the partial flow diagram starts at 100 when a user turns ON mobile data synchronization (e.g. views or activates the screen of the UE, turns on mobile phone, enables application data updates, enables email updates, enables application notification updates, etc.). At block 110, the UE determines if the user is actively using the UE. This may be by determining if the user has unlocked the UE; the user has accessed an application such as email or a web browser; the UE detects a sensor input from an accelerator, gyro or similar sensor; or the current time coincides with a user active period generated by an algorithm that tracks active and inactive periods for the user. In one example, the UE initially checks a user's active state on the UE by checking any operations performed for K minutes and no operations for K minutes indicates an inactive user. If a determination is made that the user is active, the flow moves to block 120 and the UE will synchronize data frequently using the user set preferences, for example. The frequent synchronization will continue for a certain number of cycles (e.g., one or more cycles) with each cycle being determined by a user set preference for update times (e.g., every minute, every 5 minutes, every 10 minutes, every 15 minutes, etc.). The flow then returns to block 110 after the number of cycles is complete (e.g., after 1 cycle, 2 cycles, etc.). If a determination is made that the user is inactive, the flow moves to block 130. In block 130, the UE is configured to synchronize data from the network after X minutes. X minutes may be greater than the default or user set preference to conserve battery power by reducing the frequency of network access (i.e., the UE uses the connection manager and associated antenna etc. less frequently). For example, if the default synchronization setting is to synchronize every minute, in block 130 this may be increased to every 5 minutes. Next the flow moves to block 140 after X minutes.

In block 140, the UE determines if the user has started actively using the UE. This may be by determining if the user has unlocked the UE; the user has accessed an application such as email or a web browser; the UE detects a sensor input from an accelerator, gyro or similar sensor; or the current time coincides with a user active period generated by an algorithm that tracks active and inactive periods for the user. If a determination is made that the user is active, the flow moves to block 120, and the UE will synchronize data frequently using the user set preferences, for example. The frequent synchronization will continue for a certain number of cycles (e.g., one or more cycles) with each cycle being determined by a user set preference for update times (e.g., every minute, every 5 minutes, every 10 minutes, every 15 minutes, etc.). If a determination is made that the user remains inactive, the flow moves to block 150. In block 150, the UE is configured to synchronize data from the network after X plus T1 minutes. X plus T1 minutes may be greater than X to further conserve battery power by reducing the frequency of network access (i.e., the UE uses the connection manager and associated antenna etc. less frequently). For example, if X is 5 minutes, in block 150 this may be increased to every 10 minutes. Next the flow moves to block 160 after X plus T1 minutes.

In block 160, the UE determines if the user has started actively using the UE. This may be by determining if the user has unlocked the UE; the user has accessed an application such as email or a web browser; the UE detects a sensor input from an accelerator, gyro or similar sensor; or the current time coincides with a user active period generated by an algorithm that tracks active and inactive periods for the user. If a determination is made that the user is active, the flow moves to block 120 and the UE will synchronize data frequently using the user set preferences, for example. The frequent synchronization will continue for a certain number of cycles (e.g., one or more cycles) with each cycle being determined by a user set preference for update times (e.g., every minute, every 5 minutes, every 10 minutes, every 15 minutes, etc.). If a determination is made that the user remains inactive, the flow moves to block 170.

In block 170, the UE is configured to synchronize data from the network after X plus T2 minutes. X plus T2 minutes may be greater than X plus T1 to further conserve battery power by reducing the frequency of network access (i.e., the UE uses the connection manager and associated antenna etc. less frequently). For example, if X plus T1 is 10 minutes, in block 170 this may be increased to every 15 minutes. Next the flow moves to block 180 after X plus T2 minutes and synchronizes data from the network. If in block 170, the synchronization period has reached a threshold (e.g., X plus Ty equals one hour), the flow will continue to synchronize the data from the network every X plus Ty by cycling through blocks 160-180 until a determination is made in block 160 that the user has become active. The threshold may be set for any time or number of increases as desired and it should be understood that the UE may be configured to increase the interval by the same increment every increase or by different intervals as desired until the threshold is reached. For example, T1 may be 5 minutes, T2 may be 15 minutes, T3 may be 30 minutes, T4 may be one hour, etc.

In one example, the UE initially checks a user's active state on the UE by checking any operations performed for K minutes. Once the user crosses the K minute threshold (no operations performed for >=K min), the UE informs the connection processor to increase the time to synchronize data after X minutes (i.e., increasing the synchronization time by X min). Then the connection processor synchronize operation will move into a sleep state for more time (i.e., X minutes from milliseconds). During this process, if the UE becomes active, the UE synchronizes data frequently and periodically the UE returns to checking the user's active state. After completion of sleep time X minutes, the data synchronization will occur, and if the UE is still not active then the synchronization sleep state will increase by X+T1 minutes. This process may be repeated continuously until the UE becomes active. Once the time of the synchronization sleep state reaches a threshold level of ‘X+Ty’ minutes, the timer increment stops and the UE may keep synchronizing the data for every ‘X+Ty’ minutes until the UE becomes active.

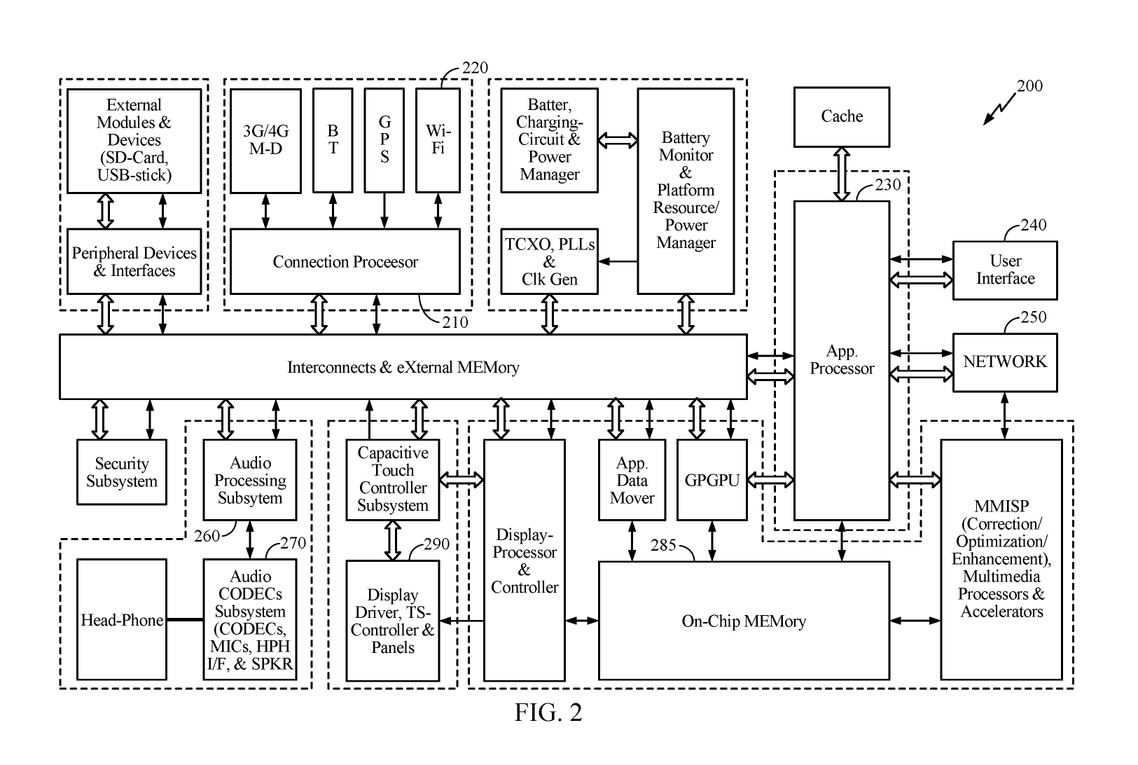

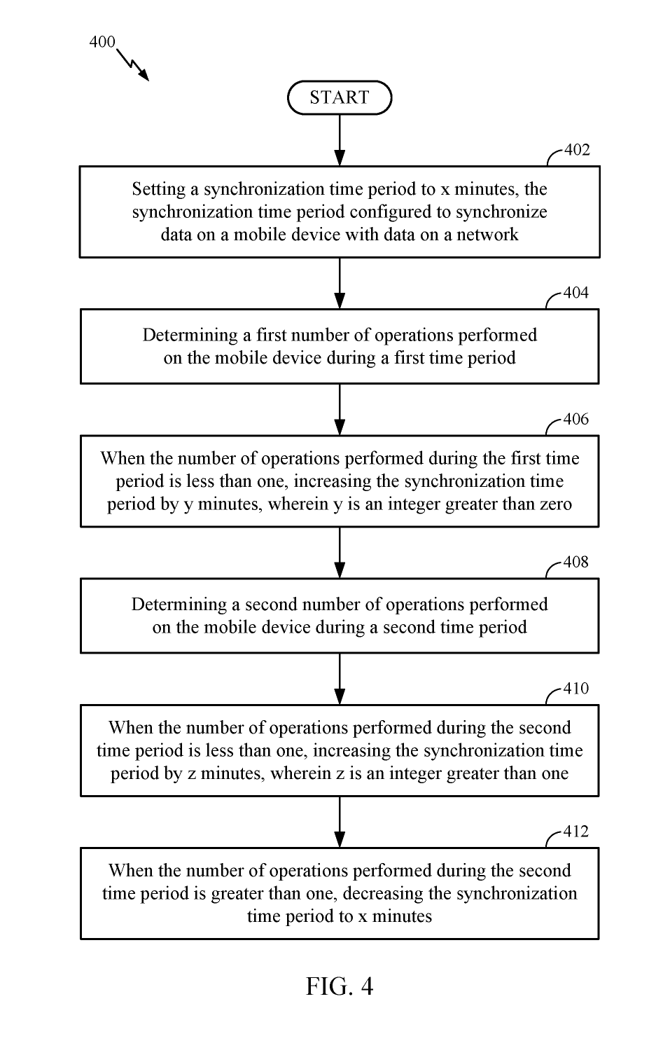

FIG. 2 illustrates an exemplary partial block diagram of a UE in accordance with some examples of the disclosure. As shown in FIG. 2, the UE 200 may include a connection processor 210 connected to a communication component 220, an application processor 230 connected to a user interface component 240, a network server 250 connected to the UE through the communication component 220, an audio processing component 260 connected to an audio codec component 270, a memory 285 coupled to the application processor 230, and a display driver component 290. The connection processor 210 is configured to activate or operate the communication component 220 as required to communicate with the network server 250 using an appropriate protocol, such as WiFi, Global Positioning Satellite (GPS), Bluetooth (BT), and 3G/4G/LTE (Cellular). The communication component 220 includes well-known circuitry and antenna for accessing the network server 250 over a wireless connection using a well-known protocol, such as WiFi, GPS, BT, and Cellular protocols. One or both of the connection processor 210 and the application processor 230 may be used to perform any of the actions described with reference to FIG. 1 or FIG. 4. The memory 285 may be configured to store software capable of enabling the UE 200 to perform any of the actions described with reference to FIG. 1 or FIG. 4 and store any of the settings for time period, number of operations, daily periods of activity, and daily periods of inactivity.

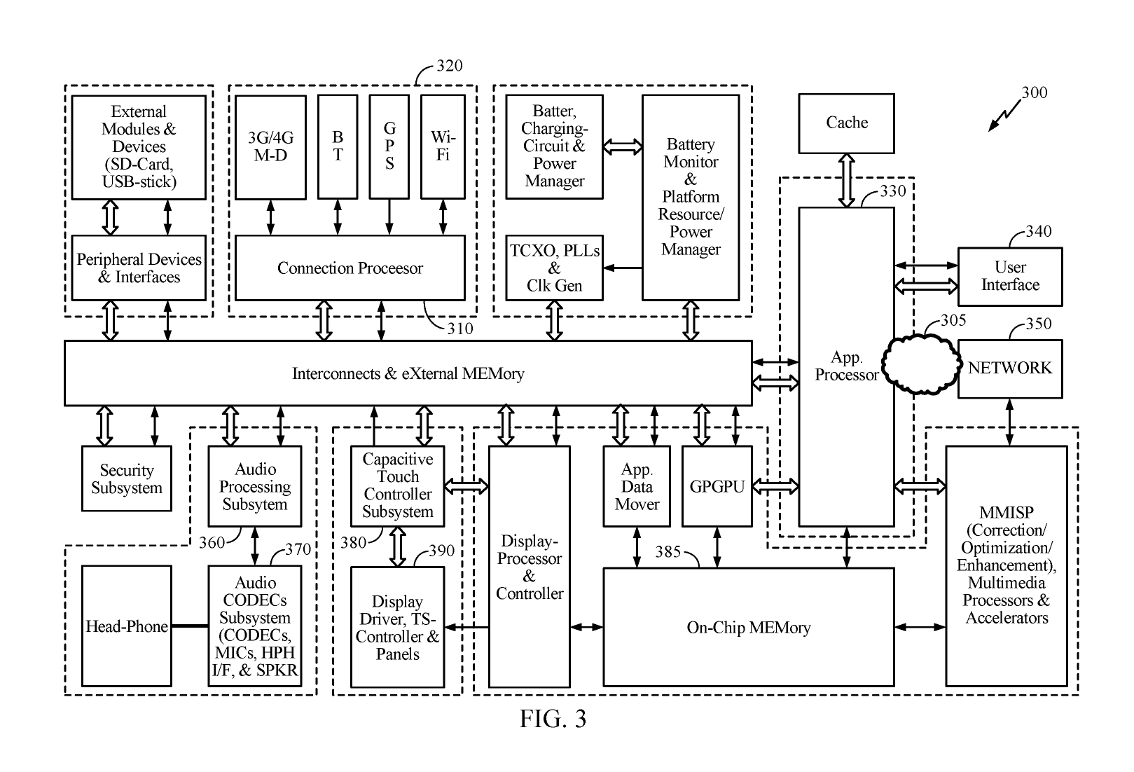

FIG. 3 illustrates another exemplary partial block diagram of a UE in accordance with some examples of the disclosure. As shown in FIG. 3, the UE 300 may be wirelessly connected to a network server 350 for remote data download/synchronization operations between the UE 300 and the network server 350. The UE 300 may include a connection processor 310 connected to a communication component 320 for handling the network connection between the UE 300 and the network server 350, an application processor 330 connected to a user interface component 340, a network server 350 connected to the UE 300 through the communication component 320, an audio processing component 360 connected to an audio codec component 370, a memory 385 coupled to the application processor 330, and a display driver component 390. The connection processor 310 is configured to activate or operate the communication component 320 as required to communicate with the network server 350 using an appropriate protocol, such as WiFi, GPS, BT, and Cellular. The communication component 320 includes well-known circuitry and antenna for accessing the network server 350 over a wireless connection using a well-known protocol, such as WiFi, GPS, BT, and Cellular protocols. One or both of the connection processor 310 and the application processor 330 may be used to perform any of the actions described with reference to FIG. 1 or FIG. 4. The memory 385 may be configured to store software capable of enabling the UE 300 to perform any of the actions described with reference to FIG. 1 or FIG. 4 and store any of the settings for time period, number of operations, daily periods of activity, and daily periods of inactivity.

The UE (i.e., UE 200 or UE 300) also may include a number of other functions. For example:

Scanning—Passive-Scanning (by listening for Beacon frames without transmitting); Active-Scanning (sending Probe-REQ frames on each channel and receiving Probe-RES); Listen/Search; Device-Discovery; Service-Discovery; Invitation Request/Response; and Group-Formation (Standard, Autonomous, and Persistent).

Association/Reassociation/Disassociation—Association is invoked the first time a station enters a network; Reassociation is requested when information from previous association is included; Join/Connect and Roam; Infrastructure or Ad-Hoc networks; and Peer-to-Peer/P2P or WiFi-Direct.

Time Synchronization—AP/GO regularly transmits Beacons to enable other stations to receive timestamps to maintain an isochronous local timer.

Coordination Function—for Contention Resolution and Avoidance; DCF/PCF/HCF, Backoff Coordination, and Slot Scheduling.

Service Management—Aggregation, Service Differentiation, Admission-Control and BW-Reservation, and Link Adaptation.

Security Management (WPS).

Power Management—requires SLEEP and causes absence disrupting AP/GO and base station communication.

The UE may also include a number of power saving functions. For example:

Constantly-Awake-Mode—to avoid hindering a node throughput, in CAM all of its power-saving features are disabled.

Wake-on-Connection—like wake-on-LAN, allows the infrastructure to initiate WakeUP of stations in DOZE.

Power-Save-Mode—allows a node to DOZE after a variable but pre-determined period of inactivity, WakeUP regularly to LISTEN and reconnect.

Unscheduled-Automatic-Power-Save-Delivery (U-APSD)—may require an AP operating in CAM queue traffic for station in SLEEP and upon WakeUP, station can asynchronously request the queued traffic.

WMM Power-Save-Mode (WMM-PSM)—AP buffers all unicast, broadcast and multicast traffic, station informs AP of its SLEEP and upon station WakeUP during TBTT, AP uses flags in TIM to inform station of its queued unicast traffic, AP sends queued unicast traffic for station during its WakeUP or when station requests with PS-Poll, AP sets a special flag in TIM to signal DTIM when sending broadcast/multicast traffic.

Synchronous-Automatic-Power-Save-Delivery (S-APSD)—is the scheduled/synchronous version of WMM-PSM.

Power-Save-Multi-Poll—is an extension to U-APSD and S-APSD that reserves a time slot for a MIMO-STA, thus temporarily silences others associated with the station.

Dynamic-MIMO-Power-Save—this technique allows MIMO PHY to scale-down to less-aggressive/low-power configurations.

WiFi-Direct Opportunistic-Power-Save—OPS allows P2P-GO SLEEP for a limited period (CTWindow) after every TBTT, when all P2P-Clients are expected not to transmit.

WiFi-Direct Notice-of-Absence—NoA requires P2P-GO advertise its SLEEP schedule to signal its associated P2P-Clients when not to transmit.

FIG. 4 illustrates an exemplary partial method of synchronizing data in accordance with some examples of the disclosure. As shown in FIG. 4, the partial method 400 starts with block 402 and setting a synchronization time period to x minutes, the synchronization time period configured to synchronize data on a mobile device with data on a network. In block 404, the partial method 400 continues with determining a first number of operations performed on the mobile device during a first time period. In block 406, the partial method 400 continues when the number of operations performed during the first time period is less than one, increasing the synchronization time period by y minutes, wherein y is an integer greater than zero. In block 408, the partial method 400 continues with determining a second number of operations performed on the mobile device during a second time period. In block 410, the partial method 400 continues when the number of operations performed during the second time period is less than one, increasing the synchronization time period by z minutes, wherein z is an integer greater than one. In block 412, the partial method 400 continues when the number of operations performed during the second time period is greater than one, decreasing the synchronization time period to x minutes.

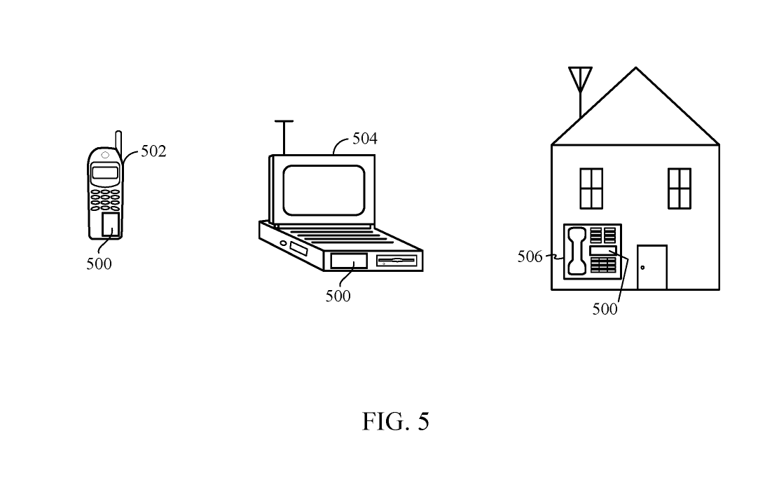

FIG. 5 illustrates various electronic devices that may be used in connection with method and devices described herein in accordance with some examples of the disclosure. For example, a mobile phone device 502, a laptop computer device 504, and a fixed location terminal device 506 may include an integrated device 500 as described herein. The integrated device 500 may be, for example, any of the integrated circuits, dies, integrated devices, integrated device packages, integrated circuit devices, device packages, integrated circuit (IC) packages, package-on-package devices described herein. The devices 502, 504, 506 illustrated in FIG. 5 are merely exemplary. Other electronic devices may also feature the integrated device 500 including, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices, servers, routers, electronic devices implemented in automotive vehicles (e.g., autonomous vehicles), or any other device that stores or retrieves data or computer instructions, or any combination thereof.

It will be appreciated that various aspects disclosed herein can be described as functional equivalents to the structures, materials and/or devices described and/or recognized by those skilled in the art. For example, in one aspect, an apparatus may comprise a means for communication (see, e.g., UE 200 in FIG. 2 or UE 300 in FIG. 3), a means for wireless connection (see, e.g., connection processor 210 or application processor 230 and communication component 220 in FIG. 2 or connection processor 310 or application processor 330 and communication component 320 in FIG. 3), means for setting a synchronization period (see, e.g., connection processor 210 and/or application processor 230 in FIG. 2 or connection processor 310 and/or application processor 330 in FIG. 3), and means for determining a number of operations (see, e.g., connection processor 210 and/or application processor 230 in FIG. 2 or connection processor 310 and/or application processor 330 in FIG. 3) of the means for communication. It will be appreciated that the aforementioned aspects are merely provided as examples and the various aspects claimed are not limited to the specific references and/or illustrations cited as examples.

Advantages of the exemplary methods and devices described herein include, but are not limited to, continuously checking if a user is active or not and synchronizing the data periodically. Because of this, a user will not miss the messages/mails that need immediate response. These approaches may be used for WiFi and Bluetooth as well as cellular connections. Machine learning may also be used to improve the determination of activity level and appropriate synchronization periods. For example, a UE may monitor a user's sleep and wake up periods and apply the algorithm accordingly so that the UE synchronizes less frequently or not at all during the monitored sleep periods.

One advantage of these approaches is power saving even when the mobile data is turned ON. For example, if a user leaves mobile data ON before sleeping. In the conventional approach, the UE continuously communicates with a base station for data synchronizing for every x milliseconds. When approaches described herein are used, if a user slept for 7 hours, the UE may only access the network for data synchronization approximately 10 to 13 times at specific intervals while the user sleeps. By the time the user wakes up, all the data will be synchronized and there will not be any flush of notifications or data only when the user unlocks the phone. With the conventional approach the UE synchronizes the data on WiFi/mobile networks more frequently.

One or more of the components, processes, features, and/or functions illustrated in FIGS. 1-5 may be rearranged and/or combined into a single component, process, feature or function or incorporated in several components, processes, or functions. Additional elements, components, processes, and/or functions may also be added without departing from the disclosure. It should also be noted that FIGS. 1-5 and its corresponding description in the present disclosure is not limited to dies and/or ICs. In some implementations, FIGS. 1-5 and its corresponding description may be used to manufacture, create, provide, and/or produce integrated devices. In some implementations, a device may include a die, an integrated device, a die package, an integrated circuit (IC), a device package, an integrated circuit (IC) package, a wafer, a semiconductor device, a package on package (PoP) device, and/or an interposer.

In this description, certain terminology is used to describe certain features. The term “mobile device” can describe, and is not limited to, a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, an automotive device in an automotive vehicle, and/or other types of portable electronic devices typically carried by a person and/or having communication capabilities (e.g., wireless, cellular, infrared, short-range radio, etc.). Further, the terms “user equipment” (UE), “mobile terminal,” “mobile device,” and “wireless device,” can be interchangeable.

The wireless communication between electronic devices can be based on different technologies, such as code division multiple access (CDMA), W-CDMA, time division multiple access (TDMA), frequency division multiple access (FDMA), Orthogonal Frequency Division Multiplexing (OFDM), Global System for Mobile Communications (GSM), 3GPP Long Term Evolution (LTE) or other protocols that may be used in a wireless communications network or a data communications network. Synchronizing data may access the network using one of the aforementioned cellular protocols or WiFi or near field communications such as Bluetooth.

The word “exemplary” is used herein to mean “serving as an example, instance, or illustration.” Any details described herein as “exemplary” is not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described hereby can be configured to perform at least a portion of a method described hereby.

The terminology used herein is for the purpose of describing particular examples and is not intended to be limiting of examples of the disclosure. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, actions, operations, elements, and/or components, but do not preclude the presence or addition of one or more other features, integers, actions, operations, elements, components, and/or groups thereof.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

Further, many examples are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be incorporated entirely within any form of computer readable storage medium having stored therein a corresponding set of computer instructions that upon execution would cause an associated processor to perform the functionality described herein. Thus, the various aspects of the disclosure may be incorporated in a number of different forms, all of which have been contemplated to be within the scope of the claimed subject matter. In addition, for each of the examples described herein, the corresponding form of any such examples may be described herein as, for example, “logic configured to” perform the described action.

Nothing stated or illustrated depicted in this application is intended to dedicate any component, action, feature, benefit, advantage, or equivalent to the public, regardless of whether the component, action, feature, benefit, advantage, or the equivalent is recited in the claims.

Further, those of skill in the art will appreciate that the various illustrative logical blocks, modules, circuits, and algorithm actions described in connection with the examples disclosed herein may be implemented as electronic hardware, computer software, or combinations of both. To clearly illustrate this interchangeability of hardware and software, various illustrative components, blocks, modules, circuits, and actions have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the examples disclosed herein may be incorporated directly in hardware, in a software module executed by a processor, or in a combination of the two. A software module may reside in a memory (e.g., memory 280 or memory 380) such as RAM memory, flash memory, ROM memory, EPROM memory, EEPROM memory, registers, hard disk, a removable disk, a CD-ROM, or any other form of non-transitory storage medium known in the art. An exemplary storage medium is coupled to the processor such that the processor can read information from, and write information to, the storage medium. In the alternative, the storage medium may be integral to the processor.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

Although some aspects have been described in connection with a device, it goes without saying that these aspects also constitute a description of the corresponding method, and so a block or a component of a device should also be understood as a corresponding method action or as a feature of a method action. Analogously thereto, aspects described in connection with or as a method action also constitute a description of a corresponding block or detail or feature of a corresponding device. Some or all of the method actions can be performed by a hardware apparatus (or using a hardware apparatus), such as, for example, a microprocessor, a programmable computer or an electronic circuit. In some examples, some or a plurality of the most important method actions can be performed by such an apparatus.

In the detailed description above it can be seen that different features are grouped together in examples. This manner of disclosure should not be understood as an intention that the claimed examples have more features than are explicitly mentioned in the respective claim. Rather, the situation is such that inventive content may reside in fewer than all features of an individual example disclosed. Therefore, the following claims should hereby be deemed to be incorporated in the description, wherein each claim by itself can stand as a separate example. Although each claim by itself can stand as a separate example, it should be noted that—although a dependent claim can refer in the claims to a specific combination with one or a plurality of claims—other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods, systems, and apparatus disclosed in the description or in the claims can be implemented by a device comprising means for performing the respective actions of this method.

Furthermore, in some examples, an individual action can be subdivided into a plurality of sub-actions or contain a plurality of sub-actions. Such sub-actions can be contained in the disclosure of the individual action and be part of the disclosure of the individual action.

While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

What is claimed is:

1. A method of synchronizing data on a mobile device, comprising:
setting a synchronization time period to x minutes, the synchronization time period configured to synchronize data on a mobile device with data on a network;
determining a first number of operations performed on the mobile device during a first time period;
when the first number of operations performed during the first time period is less than one, increasing the synchronization time period by y minutes, wherein y is an integer greater than zero;
determining a second number of operations performed on the mobile device during a second time period;
when the second number of operations performed during the second time period is less than one, increasing the synchronization time period by z minutes, wherein z is an integer greater than one; and
when the second number of operations performed during the second time period is greater than one, decreasing the synchronization time period to x minutes.

2. The method of claim 1, wherein x is a default time period.

3. The method of claim 2, further comprising:
determining a period of daily activity and a period of daily inactivity;
setting x to a first number during the period of daily activity; and
setting x to a second number greater than the first number during the period of daily inactivity.

4. The method of claim 3, wherein the period of daily activity and the period of daily inactivity are determined by a user's daily activity pattern.

5. The method of claim 1, wherein x is a user defined time period.

6. The method of claim 1, wherein y equals z.

7. The method of claim 1, wherein z is greater than y.

8. The method of claim 1, further comprising:
determining a third number of operations performed on the mobile device during a third time period;
when the third number of operations performed during the third time period is less than one, increasing the synchronization time period by w minutes, wherein w is an integer greater than one;
when the third number of operations performed during the third time period is greater than one, decreasing the synchronization time period to x minutes; and
determining a fourth number of operations performed on the mobile device during a fourth time period;
when the fourth number of operations performed during the third time period is less than one, increasing the synchronization time period by w minutes, wherein w is an integer greater than one;
when the fourth number of operations performed during the third time period is greater than one, decreasing the synchronization time period to x minutes.

9. The method of claim 1, wherein the method is incorporated into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

10. A non-transitory computer-readable medium including contents that are configured to synchronize data on a mobile device by performing a method comprising:
setting a synchronization time period to x minutes, the synchronization time period configured to synchronize data on a mobile device with data on a network;
determining a first number of operations performed on the mobile device during a first time period;
when the first number of operations performed during the first time period is less than one, increasing the synchronization time period by y minutes, wherein y is an integer greater than zero;
determining a second number of operations performed on the mobile device during a second time period;
when the second number of operations performed during the second time period is less than one, increasing the synchronization time period by z minutes, wherein z is an integer greater than one; and
when the second number of operations performed during the second time period is greater than one, decreasing the synchronization time period to x minutes.

11. The non-transitory computer-readable medium of claim 10, wherein x is a default time period.

12. The non-transitory computer-readable medium of claim 11, further comprising:
determining a period of daily activity and a period of daily inactivity;
setting x to a first number during the period of daily activity; and
setting x to a second number greater than the first number during the period of daily inactivity.

13. The non-transitory computer-readable medium of claim 12, wherein the period of daily activity and the period of daily inactivity are determined by a user's daily activity pattern.

14. The non-transitory computer-readable medium of claim 10, wherein y equals z.

15. The non-transitory computer-readable medium of claim 10, wherein z is greater than y.

16. The non-transitory computer-readable medium of claim 10, further comprising:
determining a third number of operations performed on the mobile device during a third time period;
when the third number of operations performed during the third time period is less than one, increasing the synchronization time period by w minutes, wherein w is an integer greater than one;
when the third number of operations performed during the third time period is greater than one, decreasing the synchronization time period to x minutes; and
determining a fourth number of operations performed on the mobile device during a fourth time period;
when the fourth number of operations performed during the third time period is less than one, increasing the synchronization time period by w minutes, wherein w is an integer greater than one;
when the fourth number of operations performed during the third time period is greater than one, decreasing the synchronization time period to x minutes.

17. An apparatus comprising:
a memory;
a processor coupled to the memory and configured to:
set a synchronization time period to x minutes, the synchronization time period configured to synchronize data on a mobile device with data on a network;
determine a first number of operations performed on the mobile device during a first time period;
when the first number of operations performed during the first time period is less than one, increase the synchronization time period by y minutes, wherein y is an integer greater than zero;
determine a second number of operations performed on the mobile device during a second time period;
when the second number of operations performed during the second time period is less than one, increase the synchronization time period by z minutes, wherein z is an integer greater than one; and
when the second number of operations performed during the second time period is greater than one, decrease the synchronization time period to x minutes.

18. The apparatus of claim 17, wherein x is a default time period.

19. The apparatus of claim 18, wherein the processor is further configured to:
determine a period of daily activity and a period of daily inactivity;
set x to a first number during the period of daily activity; and
set x to a second number greater than the first number during the period of daily inactivity.

20. The apparatus of claim 19, wherein the period of daily activity and the period of daily inactivity are determined by a user's daily activity pattern.
